(19) United States
(12) Patent Application Publication
(10) Pub. No.: US 2006/0153445 A1
(43) Pub. Date: Jul. 13, 2006

(54) Display methods for high dynamic range images and user interfaces for the same

(75) Inventor: Tsung-Wei Lin, Taipei (TW)

Correspondence Address: BIRCH STEWART KOLASCH & BIRCH, PO BOX 747, FALLS CHURCH, VA, 22040-0747, US

(73) Assignee: ULEAD SYSTEMS, INC.

(21) Appl. No.: 11/030,083

(22) Filed: Jan. 7, 2005

(51) Int. Cl. G06K 9/00; G06F 3/00

(52) U.S. Cl. 382/169; 715/764

(57) ABSTRACT

Display methods and interfaces for high dynamic range images. High dynamic range images and corresponding histograms are displayed on a display device. The histogram panel displays low dynamic range and high dynamic range data of the images simultaneously. The low dynamic range and high dynamic range data is brightness level of the image pixels.

### BACKGROUND

The invention relates to image display, and in particular to display methods for high dynamic range image.

The dynamic range of a scene is expressed by the contrast ratio between its brightest and darkest parts. A low dynamic range image (LDR image) can be displayed on a standard display device because of its smaller dynamic range. Due to the range limitations of LDR images, LDR images cannot represent abundant brightness of real scenes properly. Thus, high dynamic range (HDR) images are necessary. A high dynamic range image (HDR image) is typically generated by combining multiple LDR images of the same scene taken with different exposures. High dynamic range images are broadly employed in image processing systems. Rather than being displayed on a standard display device directly, high dynamic range images require a translation from high dynamic range to low dynamic range for display.

Conventionally, an image panel and histogram panel are arranged on a display device, such as a screen, to display images and corresponding histograms. The conventional histogram panel can only display the brightness of low dynamic range data of the image pixels. FIG. 1 is a diagram of an embodiment of a conventional histogram panel. The conventional histogram panel 5 can only display the brightness of low dynamic range data of the image pixels. Thus, if an image processing system processes high dynamic range images, some image parts cannot be displayed by the conventional histogram panel 5 because of the out-of-range brightness.

For example, if an image processing system comprises an image panel and a conventional histogram panel 5 as shown in FIG. 1, an HDR image may be displayed in the image panel and the brightness data of the image pixels is displayed in the corresponding conventional histogram panel 5. When the displayed image is modified, the histogram panel 5 will be difficult to reflect the actual transformed result due to limited input range of histogram panel.

Thus, methods and interfaces for high dynamic range image display are desirable.

### SUMMARY

In an exemplary embodiment of display methods for high dynamic range images, high dynamic range images and corresponding histograms are displayed on a display device. The histogram panel displays transformed low dynamic range and high dynamic range data of the images simultaneously. The low dynamic range and high dynamic range data are the brightness level of the image pixels.

### DESCRIPTION OF THE DRAWINGS

The present invention can be more fully understood by reading the subsequent detailed description and examples with references made to the accompanying drawings, wherein:

FIG. 1 is a diagram of an embodiment of a conventional histogram panel.

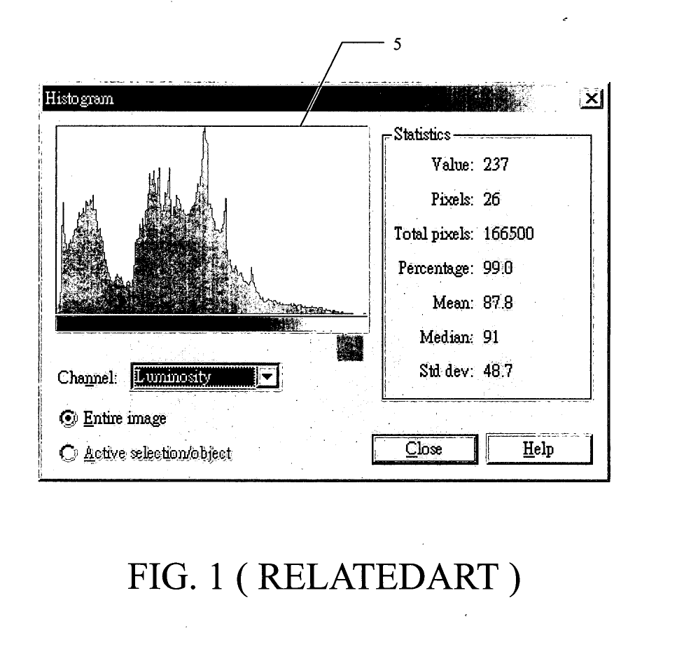

FIG. 2 is a diagram of an embodiment of a histogram panel for high dynamic range images.

FIG. 3 is a diagram of an embodiment of a user interface for high dynamic range images.

### DESCRIPTION

Display methods for high dynamic range images are provided. An image and a histogram panel are displayed on a screen. The image is a high dynamic range image and the histogram panel displays low dynamic range and high dynamic range data of the image, expressed as brightness level of the image pixels. The histogram panel displays a two-dimensional histogram, comprising a first axis, such as X-axis, to display brightness, and a second axis, such as Y-axis, to display pixel counts. The histogram panel changes corresponding histogram of the image when the brightness thereof is adjusted.

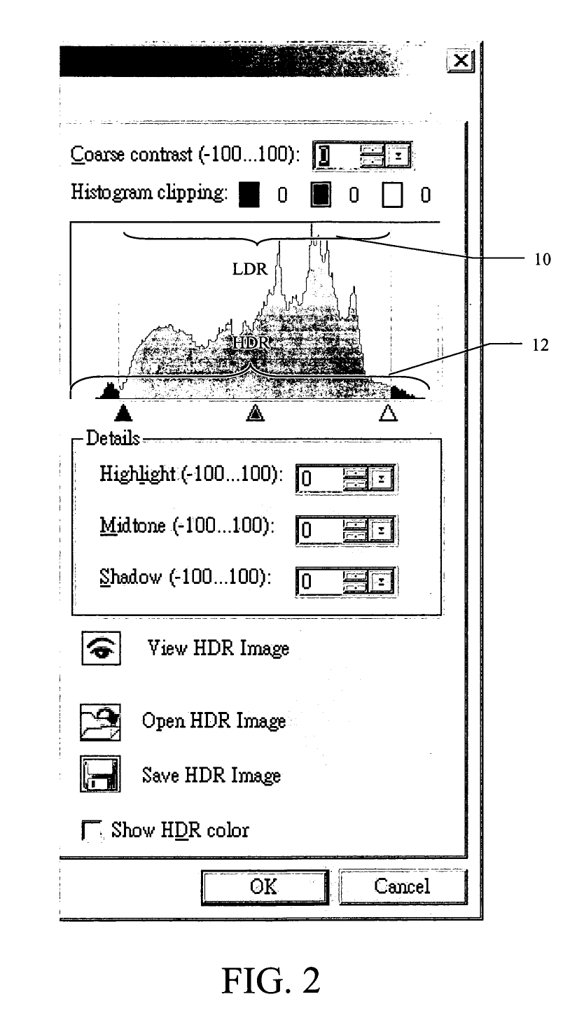

FIG. 2 is a diagram of an embodiment of a histogram panel for high dynamic range images. The histogram panel is basically divided into two parts for displaying low dynamic range and high dynamic range data. As shown in FIG. 2, part 10 displays low dynamic range data and part 12 displays high dynamic range data. When a high dynamic range image is displayed on a screen through a translation, the corresponding histogram is displayed by the histogram panel simultaneously. If the brightness of the image is adjusted, whether partially or entirely, the corresponding histogram changes accordingly. Due to the high dynamic range data display on the screen with the image, users can execute operations or manipulations on the image, such as detailed modifications, according to the high dynamic range data.

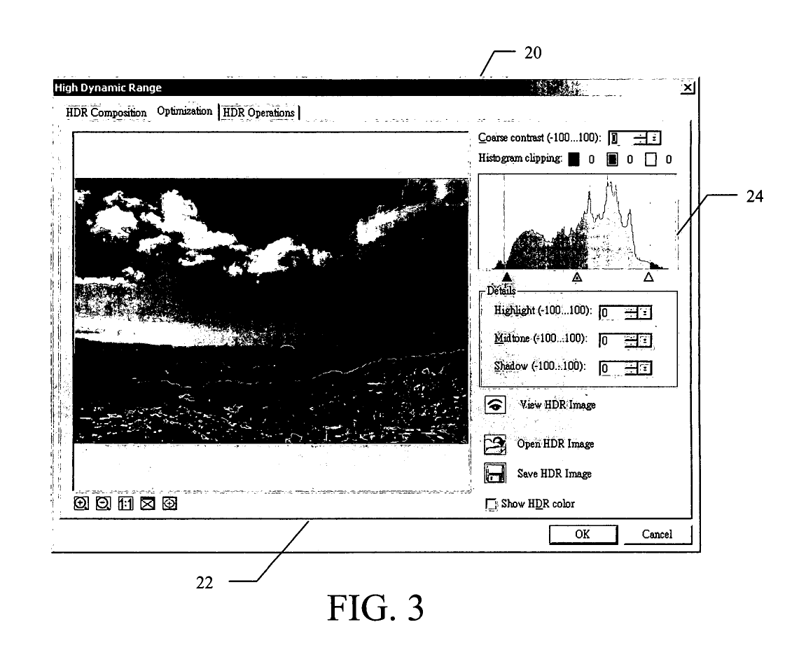

FIG. 3 is a diagram of an embodiment of a user interface for high dynamic range images. The user interface 20 comprises an image panel 22 and a histogram panel 24. The image panel 22 displays a high dynamic range image. The histogram panel 24 displays low dynamic range and high dynamic range data of the high dynamic range image, expressed as brightness level of the image pixels. The histogram panel 24 displays a two-dimensional histogram, comprising a first axis to display brightness and a second axis to display pixel counts. In some embodiments, the first axis is X-axis and the second axis is Y-axis. The histogram panel 24 changes when the brightness of the image is adjusted. The user interface 20 is displayed on a display device, such as a screen.

When the brightness of the high dynamic range image displayed on the image panel 22 is adjusted, the histogram displayed on the histogram panel 24 changes accordingly. The displayed high dynamic range data can be provided for other operations. For example, the user interface can be integrated with an image processing system for producing and processing high dynamic range images.

Thus, display methods and interfaces of high dynamic range images may potentially resolve the inconvenience of conventional high dynamic range image display methods. The disclosed methods are particularly useful for processing system for high dynamic range images.

Methods of the present invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display method for high dynamic range images, comprising displaying an image and a histogram panel on a screen, wherein the image is a high dynamic range image and the histogram panel displays low dynamic range and high dynamic range data of the image.

2. The display method for high dynamic range images as claimed in claim 1, wherein the low dynamic range and high dynamic range data is brightness level of the image pixels.

3. The display method for high dynamic range images as claimed in claim 1, wherein the histogram panel displays a two-dimensional histogram, comprising a first axis to display brightness and a second axis to display pixel counts.

4. The display method for high dynamic range images as claimed in claim 1, wherein the histogram panel changes the histogram of the image when the brightness thereof is adjusted.

5. A user interface for high dynamic range images, comprising:
an image panel, displaying a high dynamic range image; and
a histogram panel, displaying low dynamic range and high dynamic range data of the high dynamic range image.

6. The user interface for high dynamic range images as claimed in claim 5, wherein the low dynamic and high dynamic range data is brightness level of the image pixels.

7. The user interface for high dynamic range images as claimed in claim 5, wherein the histogram panel displays a two-dimensional histogram, comprising a first axis to display brightness and a second axis to display pixel counts.

8. The user interface for high dynamic range images as claimed in claim 5, wherein the histogram panel changes the histogram of the image when the brightness thereof is adjusted.

9. The user interface for high dynamic range images as claimed in claim 5, wherein the user interface is displayed on a display device.
